(19) United States
(12) Patent Application Publication
(10) Pub. No.: US 2008/0026152 A1
(43) Pub. Date: Jan. 31, 2008

(54) Process for post-treatment of amine-based preservative-treated wood

(76) Inventors: James A. Brient, Missouri City, TX (US); Kenneth M. Hardy, Houston, TX (US); Gerald E. Davis, Bellaire, TX (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/495,429

(22) Filed: Jul. 28, 2006

(51) Int. Cl. B05D 3/04; B05D 1/18

(52) U.S. Cl. 427/377; 427/440

(57) ABSTRACT

Water-borne amine-based preservative-impregnated wood is post-treated by: (a) contacting the preservative-impregnated wood in a closed vessel with live steam; (b) collecting a water-containing condensate generated in the vessel; and (c) recovering the post-treated wood from the vessel.

### FIELD OF THE INVENTION

Our invention relates to a process for post-treating wood that has been freshly preserved using a water-borne amine-based preservative. More particularly, the process of our invention involves a sequence of steps using steam to remove copper-amine preservative residue from the surface of the treated wood to reduce the nitrogen source that causes the growth of mold-fungi.

### BACKGROUND OF THE INVENTION

In order to prevent decay of wood and timbers, and thereby increasing their life, it is common practice to impregnate the wood or timbers with either an oil-based or water-borne preservative. Oil-based preservatives include creosote, mixtures of inorganic compounds dissolved or dispersed in water, or certain organic or metallo-organic compounds which are dissolved in organic solvents. Water-borne preservatives include copper-based compounds that employ amines such as monoethanolamine to maintain the stability of the copper and to aid in the penetration of the preservative into the wood. Copper-amine solutions are deep blue color, and the resulting treated wood usually has a decidedly unnatural blue-green tint. Although the color may dissipate over time, wood treaters have found that they often have to add artificial colorants to mask the color produced after treating the wood with copper-amine preservatives.

The presence of amine in and on the wood as a result of the preservative treatment unfortunately promotes the growth of mold fungi, which imparts a cosmetically unpleasing appearance that some equate with potential human health issues. The mold fungi growth is believed caused by the amine in the preservative treatment solution because it acts as a nitrogen source for the mold fungi. In fact, the art has recognized that amines and/or ammonia in the current soluble copper wood treatments are responsible for increased mold, e.g., sapstain mold, as the ammonia and/or amines provide bio-available nitrogen. Oil based preservatives, as described above, generally do not have this problem due to the absence of amines in the preservative formulation and because oily residues usually remain on the wood surface.

The most common commercial procedure for impregnating wood involves subjecting the wood to the preservative under relatively high pressures and sometimes at relatively high temperatures. Normally, the procedure involves placing the wood in a vessel, filling the vessel with the preservative mixture and raising the pressure within the vessel to the desired level to effect penetration of the solution into the wood. Sometimes, the temperature of the liquid within the vessel is raised to an elevated temperature. After the wood has been subjected to the penetrating system for the desired period of time, the pressure is reduced, generally, to atmospheric pressure, and as the pressure is reduced, some of the penetrating solution contained in the wood is forced out of the wood by expansion of the air within the wood as the external pressure is reduced. This penetrating solution which is released and recovered from the wood as the external pressure is reduced is generally referred to in the art as “kickback”. When the term is used in this application, it shall have the same meaning.

Sometimes, especially with oil-borne preservatives, before the wood is removed from the vessel, it is subjected to a “post-treatment” to recover additional kickback, or to clean the surface of the final treated product and/or to improve the color of the treated product. Known post-treating procedures are descried in U.S. Pat. No. 5,080,935, most typically involve the use of steam or hot water.

Although the above-described prior art recognizes the use of steam to post-treat wood that has been treated with an oil-based preservative solution we are unaware of any processes that employ steam in a post-treatment step when wood has been treated with an amine-based preservative, especially when a copper-amine preservative is used. Likewise, we are unaware of any post-treatment process on wood treated with an amine-based preservative that is effective in reducing the growth of mold fungi. Our process, as will be described in detail below, fulfills a need in the art for a post-treatment process that reduces the unpleasant color caused by copper-amine treated wood and reduces the growth of mold fungi. Our process also produces a finished wood product with a more natural wood appearance, negating the need for added colorants that add cost and processing complexity. In the course of heating the wood to elevated temperatures, our process also will reduce leaching of preservative from the wood by increasing the rate of fixation of copper to the wood. An added advantage to our process is the improved odor of wood treated with certain copper-amine preservatives.

### SUMMARY OF THE INVENTION

An improved process for the post-treatment of water-borne amine-based preservative-treated wood is described. More particularly, the improved process comprises, in one embodiment, the steps of

(a) contacting water-borne amine-based preservative impregnated wood in a closed vessel with steam;

(b) collecting and removing the water condensate from the vessel during the steam post-treatment; and

(c) recovering the post-treated wood from the vessel.

### DESCRIPTION OF THE PREFERRED EMBODIMENTS

Our invention is a process for the post-treatment of water-borne amine-based preservative-treated wood using steam in a closed vessel. In particular, our process is directed to wood that has been preserved using a copper-amine formulation. The improved process uses a sequence of steps to steam-clean the preservative impregnated wood to provide a clean and dry surface that reduces the amine content of the wood surface so as greatly reduce the growth of mold fungi. Our process thus negates the need to add moldicides that add cost and processing complexity. Our process also produces a finished wood product with a more natural wood appearance, negating the need for added colorants that add cost and processing complexity.

The preservative-impregnated wood which can be post-treated in accordance with the present invention may be air-seasoned or kiln-dried wood which has been impregnated with one or more of a variety of known water-borne preservatives dissolved in an amine-based formulation. In one preferred embodiment, the preservative is applied to the wood as a water-borne solution having active ingredients such as alkaline copper-quat (ACQ), copper azole, copper naphthenate, copper xyligen, or any other water-borne copper amine formulation.

A variety of preservative-impregnated wood types can be post-treated in accordance with the present invention. Examples of wood species which can be treated in accordance with the present invention include Southern Yellow Pine, Western Red Cedar, coastal Douglas fir, Hem-fir, Lodgepole pine, Jack pine, Red pine, Ponderosa pine, etc.

The impregnated wood which is subjected to the post-treatment process of our invention is wood which has been impregnated with a water-borne amine-based preservative in either a full cell (Bethell) or an empty-cell process (either Rueping or Lowry). In the empty-cell process, dried wood is loaded into a vessel or retort and an initial air pressure is applied. The pressure generally is about 0 psig for the Lowry process and is typically about 20-40 psig for the Rueping process. The vessel is then filled at the initial air pressure with the solution of the preservative, and the pressure and temperature are increased to appropriate values such as 150-200 psig and 100°-150° F., depending on wood species and preservative. The temperature and pressure are maintained for a period of time to achieve an appropriate penetration and retention of the preservative in the wood. The pressure is then released and after venting to atmospheric pressure, the preservative solution is removed from the vessel. A vacuum is applied to the wood in the vessel and maintained for an appropriate time to produce the “vacuum drip”. After an appropriate time, the vacuum is released and the vessel vented to atmospheric pressure. The drippings formed during the vacuum step are removed from the vessel, and the wood is now in condition for the post-treatment process of the present invention.

In the full cell or modified full cell process, dried wood is loaded into a vessel or retort and an initial vacuum is applied. The vacuum generally is about 20 inches or more of mercury for the full cell process and is typically about 10-15 inches of mercury for the modified full cell process. The vessel is then filled with the solution of the preservative while maintaining vacuum, and the pressure and temperature are increased to appropriate values such as 150-200 psig and 100°-150° F., depending on wood species and preservative. The temperature and pressure are maintained for a period of time to achieve an appropriate penetration and retention of the preservative in the wood. The pressure is then released and after venting to atmospheric pressure, the preservative solution is removed from the vessel. A vacuum is applied to the wood in the vessel and maintained for an appropriate time to produce the “vacuum drip”. After an appropriate time, the vacuum is released and the vessel vented to atmospheric pressure. The drippings formed during the vacuum step are removed from the vessel, and the wood is now in condition for the post-treatment process of the present invention.

In the first step of one embodiment of the post-treating process of our invention, live steam is added to the closed vessel which contains the preservative impregnated wood. The term “live steam” is used in this specification and claims to refer to steam which is introduced into the vessel from an external source as distinguished from steam generated in situ by heating water contained in the vessel.

In one preferred embodiment, live steam is added to the vessel while the vessel and the wood contained therein are still warm from the impregnation process. Generally, the temperature of the vessel and the wood contained in the vessel will be in the range of from 150° F. to 200° F. The steam is added to the closed vessel at about 0-20 psig and the temperature of the live steam added to the closed vessel is about 225°-240° F. A water condensate collects in the closed vessel during this step. The steam injection step can last from about 30 to about 120 minutes depending on the amount and type of wood receiving the post-treatment.

Once the impregnated wood has been subjected to the steam and the resulting water condensate has been removed, the post-treated wood then can be removed from the vessel. A final vacuum of 30-60 minutes duration can optionally be applied to fully dry the wood. The collected and removed condensate can be easily disposed of or returned to the process for reuse.

A benefit of our process is that the resultant post-treated wood has a natural looking brown color as opposed to the blue-green color of non-treated wood. In addition, the post-treatment step does not reduce the copper content of the wood, thus maintaining the preservative benefits. The reduced amine does, however, greatly reduce the potential for mold fungi to grow on the wood surface.

In another embodiment of the post-treating process of the present invention, the first step involves adding hot water, preferably at about 150°-200° F., to a vessel containing the preservative impregnated wood to generate “closed steam” rather than live steam as described above. Generally, the water is added to the vessel while the vessel and wood contained therein are still warm from the impregnation process. The addition of small amounts of water, e.g., less than a few percent of the volume of the vessel is one advantage of the process of the invention.

In the next step, heat and or a vacuum is applied to allow the water in the vessel to vaporize water and generate steam in the vessel as in the steam embodiment described above. The remaining steps in this embodiment are similar to the preferred process wherein steam is added in a first step to a closed vessel containing the water-borne amine-based preservative-impregnated wood.

In another embodiment of the post-treating process of the present invention, hot water, preferably at about 150°-200° F., is added to the vessel containing the preservative impregnated wood and heated in an “expansion bath” rather than using live or closed steam as described above. The elevated temperature similarly removes residual treating solution to affect the benefits of the present invention.

The following examples illustrate the post-treatment process of the present invention. Unless otherwise specifically indicated in the following examples and elsewhere in the specification and claims, all parts and percentages are by weight, and all temperatures are in degrees Fahrenheit.

### EXAMPLE 1

Southern pine 2×4 lumber was treated with waterborne copper naphthenate using a Bethell (full cell) process whereby a 1-hour full vacuum (28″ Hg) was followed by pressure treating for 2 hours at 140-150 psig. After pressure was released and treating solution was drained from the retort, live stream at approximately 9 psig was blown into the wood-filled retort at 108° C. for 30 minutes. Copper retention in the treated wood was 0.06 lb/cu. ft. before and after steam treatment. The steam treated wood was turned brown and lost most of the green color of the non-steamed wood.

### EXAMPLE 2

¾×¾″ stakes stacked in bundles of 7×7 pieces were treated with waterborne copper naphthenate to the AWPA ground contact retention standard of 0.11 pcf as copper. The bundled stakes were then subjected to post-treatment steaming for times ranging from 15 minutes to 1 hour to determine the time necessary to remove surface ethanolamine and remove the green coloration. Steaming times of 30 minutes or more at a rate of 18 pounds per hour was sufficient to remove the surface green color from both exterior and interior stakes in the bundle, which turned a medium- to light brown-yellow color. Analysis of the steam condensate collected from an overhead port from post treatment steaming of lumber showed wood organic compounds such as terpenes, acetic acid, etc., but no appreciable copper content.

### EXAMPLE 3

15 minutes at 15 to 20 lbs steam per hour was found to be sufficient to remove residual/surface ethanolamine in the treating cylinder with 8 stickered 1×4 southern pine (total lumber=0.35 cu ft).

### EXAMPLE 4

Southern yellow pine 1×4 lumber was treated to ground contact retention levels with waterborne copper naphthenate. Half of the material was dead stacked while still wet and either left in the open or wrapped in dark plastic to promote mold growth. The other half was subjected to a 30 minute post-treatment steaming before storing under similar conditions. After 3 weeks wrapped in plastic, none of the samples showed signs of mold growth, but mold growth after 4 months showed a marked difference when post-treatment steaming was employed. Wood stacked in the open air (not in plastic) showed almost no mold on steamed samples compared to moderate mold growth on wood without post-treatment steaming. Both samples wrapped in dark plastic for 4 months showed mold growth, but the steamed samples had noticeably less surface mold than non-steamed samples.

### EXAMPLE 5

Southern yellow pine sapwood boards were treated using a variety of waterborne copper-based wood preservatives, including acid copper chromate, chromated copper arsenate, copper azole, and copper naphthenate, the latter two systems containing amines as solubilizing agents. A full cell wood treatment process was used to impregnate the wood, which included an initial vacuum at 25 inch Hg for 20 minutes, followed by a pressure at 160 psi for 60 minutes with no final vacuum. Wood samples were treated to achieve 0.05, 0.10, and 0.20 pcf copper retentions. Borings were removed from each treated board and maintained at 4°, 22°, 50° and 80° C. to perform the leaching-fixation test and to determine the copper retention of un-leached borings.

Wood samples were held at temperature for up to 56 days, with samples periodically removed from the controlled temperature chamber and leached with deionized water for 4 hours. The leached wood and leachate water were assayed for copper to determine fixation as a function of time, temperature, and initial copper retention in the wood. In all cases, copper leaching was lower at elevated temperatures as are achieved by post-treatment steaming by the process of the present invention.

We claim:

1. An improved process for impregnating wood with a water-borne amine-based preservative solution in an impregnating vessel, wherein the improvement comprises subjecting the freshly preservative-impregnated wood to a post-treatment after the preservative solution is removed from the impregnating vessel, said post-treatment comprising the steps of:
(a) contacting the water-borne amine-based preservative-impregnated wood in a closed vessel with steam;
(b) collecting and removing a water-containing condensate formed in the vessel; and
(c) recovering the post-treated wood from the vessel.

2. The process of claim 1 wherein the water-borne-preservative is copper-amine solution.

3. The process of claim 1 wherein the vessel used in step (a) is the same vessel used for preservative impregnation of the wood.

4. The process of claim 1 wherein the pressure within the closed vessel in step (a) is about 0 psig to about 20 psig.

5. The process of claim 1 wherein the temperature of the steam in step (a) is about 225°-240° F.

6. The process of claim 1 wherein the time for step (a) is from about 30 minutes to about 120 minutes.

7. An improved process for impregnating wood with water-borne amine-based preservative solution in an impregnating vessel, wherein the improvement comprises subjecting freshly preservative-impregnated wood to a post-treatment after the preservative solution is removed from the impregnating vessel, said post-treatment comprising the steps of:
(a) contacting wood that has been impregnated with a copper-amine water-borne solution in a closed vessel with steam, at a temperature of about 225°-240° F. at 0 to 20 psig for a period up to 2 hours;
(b) collecting and removing a water-containing condensate formed in the vessel; and
(c) recovering the post-treated wood from the vessel.

8. The process of claim 7 wherein essentially all of the water condensate in the vessel is removed by distillation under vacuum in step (b).

9. The process of claim 8 wherein the vacuum is maintained in step (b) for a period of from about 20 to about 60 minutes.
